(19) United States
(12) Patent Application Publication
(10) Pub. No.: US 2011/0137664 A1
(43) Pub. Date: Jun. 9, 2011

(54) Providing Schedule Related Information to External Entities

(75) Inventors: Nancy Ellen Kho, Belmont, MA (US); Judy J. Piper, Woburn, MA (US); Mary Ellen Zurko, Groton, MA (US)

(73) Assignee: INTERNATIONAL BUSINESS MACHINES CORPORATION, Armonk, NY (US)

(21) Appl. No.: 12/634,485

(22) Filed: Dec. 9, 2009

(51) Int. Cl. G06Q 30/00; G06F 12/00

(52) U.S. Cl. 705/1.1; 711/154; 711/E12.001

(57) ABSTRACT

A method for providing schedule related information to external entities includes storing schedule data of a user on a server, the schedule data corresponding to a computerized calendar service; exposing, with the computerized calendar service, at least a portion of the schedule data to an entity other than the user; and enabling the entity to communicate an offer based on the schedule data to at least the user.

### BACKGROUND

Aspects of the present invention relate generally to advertising solutions for providers of products and services. More particularly, aspects of the present invention relate to enabling providers of products and services to make offers to potential consumers.

People often spend a great deal of time searching for the best bargain for airline tickets, hotel reservations, transportation reservations, dining reservations, and other products and services that are dependent on the schedule of the user. It is common for a potential consumer of such products or services to purchase or reserve the products or services on the Internet after examining competing prices and services online. Despite the convenience that the Internet provides to this process, it can be a rather time consuming affair to sift through the enormous variety of such products and services available online.

Further complicating the process of selecting a schedule-dependent product or service is the fact that prices for such products and services generally fluctuate according to the date for which the product or service is needed. For example, airlines may discount or raise airfare ticket prices for a season depending on observed travel trends during that season. As such, a consumer that purchases a schedule-dependent product or service cannot necessarily rely on that product or service being available for a later engagement at the same rates.

### BRIEF SUMMARY

A method for providing schedule related information to external entities includes storing schedule data of a user on a server, the schedule data corresponding to a computerized calendar service; exposing, with the computerized calendar service, at least a portion of the schedule data to an entity other than the user; and enabling the entity to communicate an offer based on the schedule data to at least the user.

A server system includes a processor and a memory communicatively coupled to the processor. The processor is configured to: store schedule data of a user on the memory, the schedule data corresponding to a calendar service; expose, with the calendar service, at least a portion of the schedule data to an entity other than the user; and enable the entity to communicate an offer based on the schedule data to at least the user.

A computer program product for providing schedule related information to external entities includes a computer readable storage medium having computer readable program code embodied therewith. The computer readable program code includes computer readable program code configured to store schedule data of a user on the memory, the schedule data corresponding to a calendar service; computer readable program code configured to expose, with the calendar service, at least a portion of the schedule data to an entity other than the user; and computer readable program code configured to enable the entity to communicate an offer based on the schedule data to at least the user.

### BRIEF DESCRIPTION OF THE SEVERAL VIEWS OF THE DRAWINGS

The accompanying drawings illustrate various embodiments of the principles described herein and are a part of the specification. The illustrated embodiments are merely examples and do not limit the scope of the claims.

FIG. 1 is a diagram showing an illustrative schedule related advertisement system, according to one embodiment of principles described herein.

FIG. 2 is a diagram showing an illustrative calendar application allowing a user to publish any calendar items to a number of entities, according to one embodiment of principles described herein.

FIG. 3 is a diagram showing an illustrative calendar application allowing a user to specify details relative to an item which is to be published to a number of entities, according to embodiment of principles described herein.

FIG. 4A is a diagram showing an illustrative calendar application including an offer notification, according to one embodiment of principles described herein.

FIG. 4B is a diagram showing an illustrative calendar application displaying details related to a received offer, according to one embodiment of principles described herein.

FIG. 5 is a flowchart showing an illustrative method for publishing schedule items within a calendar application to a number of entities and allowing the entities to make offers to a user of the calendar application, according to one embodiment of principles described herein.

Throughout the drawings, identical reference numbers designate similar, but not necessarily identical, elements.

### DETAILED DESCRIPTION

The present specification relates to systems and methods for providing a means for business entities to make offers related to their services based on information stored in a potential customer's computerized calendar system. According to certain embodiments, a user may enter schedule data into his or her calendar system. The user may then wish to make that schedule data available to a number of external entities. For example, if a user is seeking an airline ticket on a particular date, the user may enter his or her trip into the calendar system and choose to make that trip information available to a number of airline companies. The schedule data from the user's calendar system may be placed into a database which is available to the airline companies. The airline companies may then be able to make a specialized offer to the user based on the information provided.

Methods and systems embodying principles described herein may provide a user with a simple means to find an acceptable price for a desired service based on the schedule of the user. Since offers may be made to the user based on data the user would have entered into the calendar system anyway, the user may not have to spend a great deal of time searching through the various online services available to find the best rate for a flight, hotel, or other schedule dependent service.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

Throughout this specification and in the appended claims, the term “server” is to be broadly interpreted as a physical computing system configured to provide a service to another physical computing system. A server may include an application server, a storage server, or a web server. In a peer-to-peer network configuration, each peer system may act as a server.

Throughout this specification and in the appended claims, the term “user” refers to any entity for which a schedule may be created in a computerized calendar system. For example, a “user” within the scope of this definition may include an individual a group of individuals, or an organization. A user may also be an individual interacting with a computer system in a representative capacity on behalf of a larger entity. For example, a user may be an employee of a corporation who is entering schedule data into a corporate calendar system.

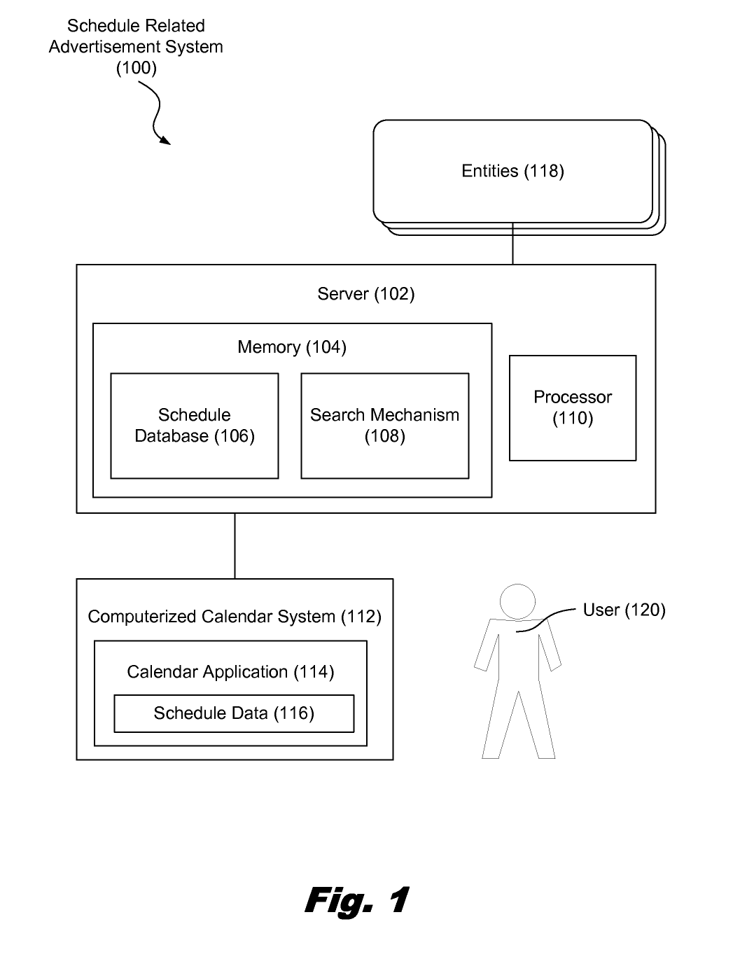

Referring now to the figures, FIG. 1 is a diagram showing an illustrative schedule related advertisement system (100). According to certain embodiments, a server (102) may include a processor (110) and a memory (104) having a schedule database (106) and a search mechanism (108) stored thereon. The server may be communicatively coupled to a computerized calendar system (112) which includes a calendar application (114) having schedule data (116) associated therewith. The server may also be communicatively coupled to the systems belonging to a number of entities (118).

A server (102) is a physical computing system which is configured to provide various services to a number of client systems which may be communicatively coupled to the server (102). Some server (102) systems may be optimized for mass storage while other server (102) systems may be optimized for processing services.

A typical physical computing system such as a server generally includes a form of memory (104). There are many types of memory available. Some types of memory, such as hard disk drives, optical disc drives, and solid state drives, are designed for storage. These types of memory typically have large storage volume but relatively slow performance. Other types of memory, such as those used for Random Access Memory (RAM), are optimized for speed and are often referred to as “working memory.” The various forms of memory may store information in the form of data and software.

A database (106) is a set of logically related records which allows efficient searching based on characteristics are attributes associated with each record. A search mechanism (108) may then be used to search the database based on a particular characteristic or attribute associated with the records. A schedule database (106) may be used to store records of schedule items (116) which have been entered into a number of computerized calendar systems (112) communicatively connected to the server (102).

Many people use various calendar applications (114) to manage their busy schedules. Calendar applications typically allow a user to add schedule data (116) having a particular date and time. The schedule data (116) may include information regarding whatever the event a user is scheduling. For example, if a user has a meeting to go to at a particular date and time, the schedule item may contain information regarding the purpose and the location of the meeting in addition to the date and time. In a further example, a user may be planning a trip in which a flight and hotel will be needed. The schedule item for the trip may contain information such as a travel destination, desired time of departure and return, type of hotel desired, type of car rental, and other information related to the trip.

Several entities (118) such as airlines, hotels, and travel agencies may find it useful to have access to information regarding a potential customer's trip. Many businesses actively promote special deals to fill vacancies in order to maximize their profits. Businesses may advertise to people who have signed up for a mailing list to receive special offers. Additionally, businesses may place advertisements within travel sites such as Expedia, Travelocity, and Priceline. Although these techniques may help businesses fill their vacancies, they may not be as targeted as some businesses would prefer. By allowing users (120) to publish their trip information along with information about desired services, businesses may be able to better target potential customers by creating specialized deals and packaged services to specific individuals. In addition, the user (120) does not need to spend a great amount of time searching for acceptable rates and services.

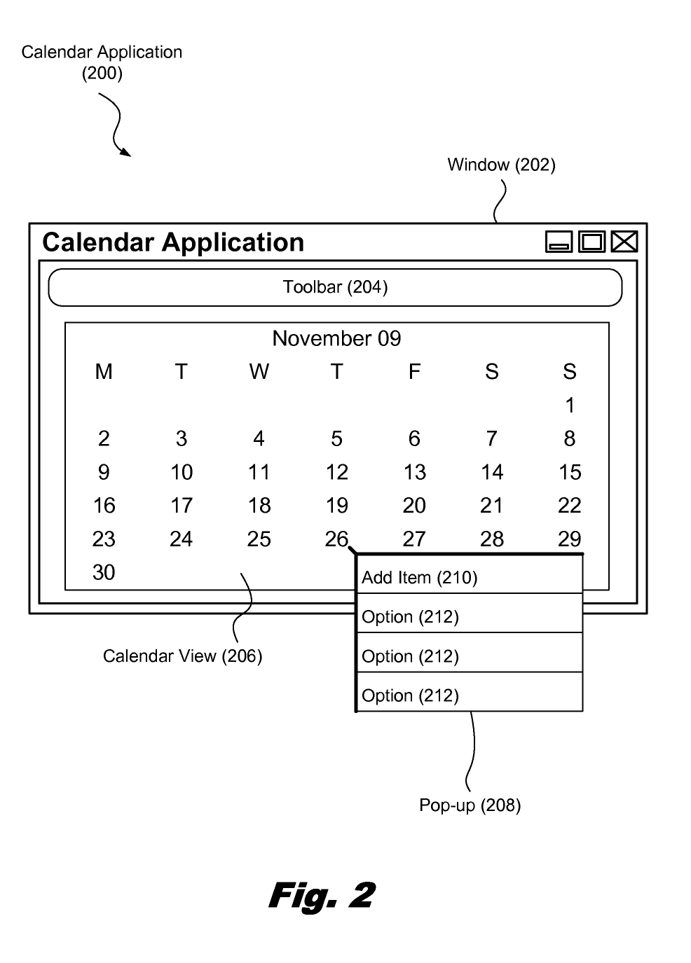

FIG. 2 is a diagram showing an illustrative calendar application allowing a user to publish any calendar items to a number of entities. According to certain embodiments, a calendar application (200) may include a window (202) which displays a toolbar (204) and a calendar view (206). The calendar application (200) may be configured to display a pop-up (208) in response to a user clicking on a displayed calendar date. The pop-up (208) may include a number of options (212) including an add item (210) option.

A computer application is typically displayed in the form of a window (202). Each element displayed within the window (202) relates to the various functions of the application. An application typically includes a toolbar (204). The toolbar may provide a user with a variety of tools and options relating to the application.

In certain embodiments, a calendar application (200) may display a calendar view (206) on a month-by-month basis. A user may be able to use an input device such as a mouse or touchpad to move a cursor. The cursor may be used to select a particular date shown within the calendar view (206). When selecting a particular date, a pop-up menu (208) may appear in association with the selected date.

The pop-up menu (208) may include several options (210) relating to operations which may be performed on the calendar date selected. One option may be to add a scheduled item (210). This option may allow a user to enter new information regarding a planned trip or event which may require various products and services.

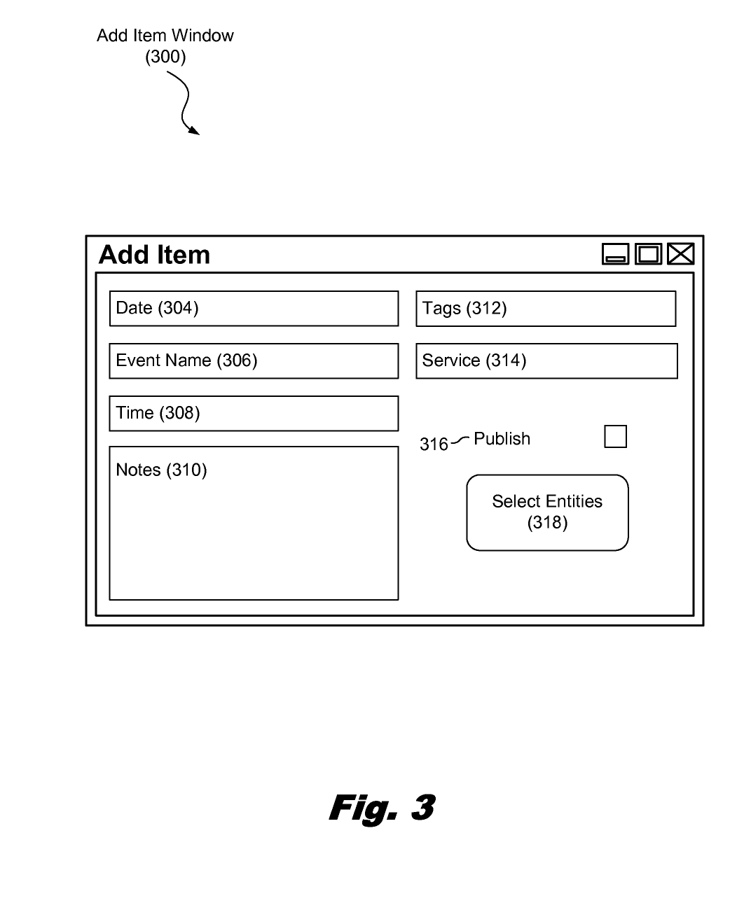

FIG. 3 is a diagram showing an illustrative add item window (300) for a calendar application allowing a user to specify details relative to an item which is to be published to a number of entities. According to certain embodiments, an add item window may include text fields for a user to enter a date (304), an event name (305), a time (308), notes (310), and tags (312). The user may also be able to select a service (314) and check a box if it is desired to publish the item to a number of entities. The user may also select (318) which entities in which to publish the item.

In certain embodiments, the add item window (300) may display the date (304) in which the scheduled event is to take place. This may be a specific date or a range of dates. A user may assign a name (306) to the scheduled event. A user may also specify a time (308) in which the scheduled item is to take place. The time (308) information may be either a specific starting time or a time range.

A user may be provided with a means to enter various notes (310) relating to a scheduled item. For example, a user may enter information relating to the trip such as the destination, purpose of the trip, longevity of the trip, other people who will accompany the user, etc. The notes (310) section may be used to help businesses customize their offers to the user.

In certain embodiments, a user may be able to place tags with a scheduled items. The tags may comprise keywords associated with a desired service or product. For example, a user may use the tags flight, San Francisco to New York City, round trip, hotel, and car rental. A search mechanism used to search the database containing a number of scheduled items will be able to find items based on these tags. For example, if an airline company wants to fill a flight from San Francisco to New York City, then they may search for items having the tag “San Francisco to New York City.” They may then be able to look at other tags such as hotel and car rental and create a customized packaged deal for the potential customer based on those tags.

In some embodiments, a user may simply specify which services they are looking for. The service text field (314) may allow a user to enter at least one desired service. For example, the user may enter the words flight and car rental. This may indicate that the user is looking for a flight and a car rental, but not necessarily a hotel. This may allow businesses to offer customized package deals containing only the services and products desired by the potential customer.

In some cases, a user may wish to add a scheduled item but not make it available to an outside entity. This may be the case if the user has already made travel and lodging arrangements or the scheduled item simply does not require any such services. In certain embodiments, a checkbox may be provided in the add item window (300) which may allow a user to specify whether or not they wish for the currently displayed scheduled item to be made available to any outside entities.

In certain embodiments, when a user chooses to publish any schedule data to an outside entity, the user may specify exactly which entities to publish the data. In some cases, a user may wish to publish his or her schedule data to only a preferred entity. For example, a user may have a favorite hotel chain. Thus, the user may wish to publish his or her schedule data to agents of that particular hotel chain. Furthermore, if a user has a preferred airline, the user may wish to publish his or her schedule data to the preferred airline. As a result, the user may not be bothered with offers in which he or she knows will likely be unacceptable.

In certain embodiments, a user may choose to publish schedule data to a search entity. This may allow a number of organizations to search through the data. The schedule data may go through the hands of several different entities until it reaches an entity that will make an offer.

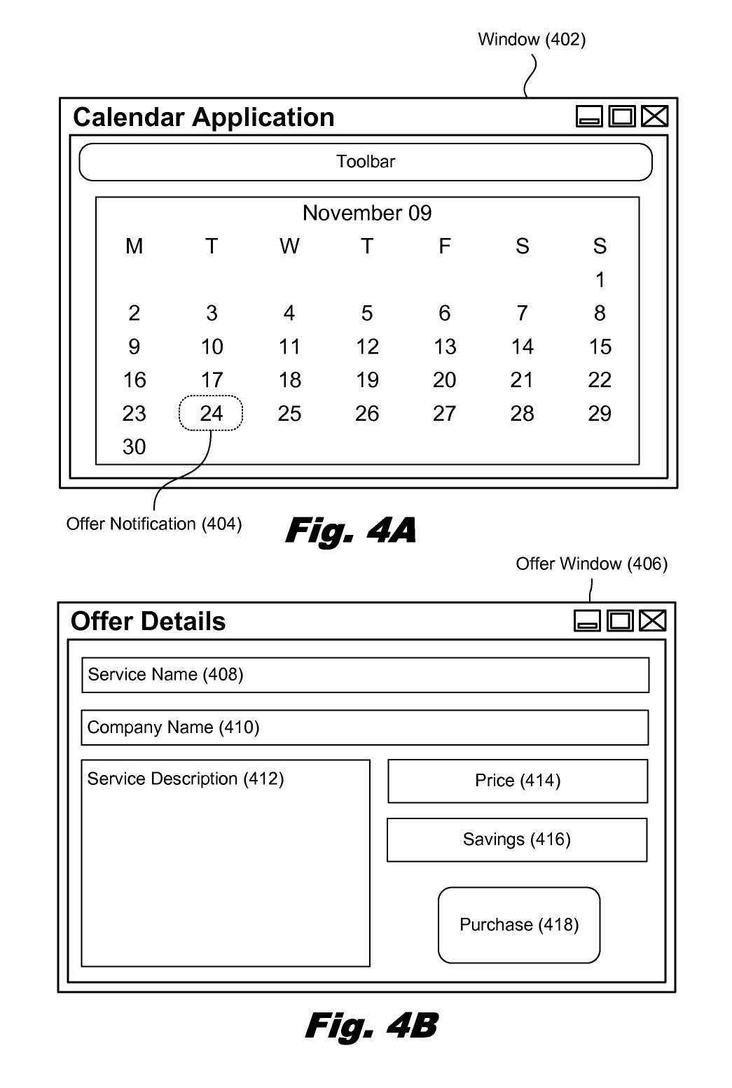

In some embodiments, a user may receive an offer directly through the calendar application used to publish the schedule data from which the offer is based. FIGS. 4A and 4B show illustrative application windows which may display an offer.

FIG. 4A is a diagram showing an illustrative window (402) for a calendar application (400) including an offer notification (404). According to certain embodiments, a calendar view may have a particular date marked to indicate that an offer has been made regarding an item which was added for that date. The marking may be done through a variety of means including, but not limited to, bordering the date, bolding the date, and circling the date.

FIG. 4B is a diagram showing an illustrative offer window associated with a calendar application. According to certain embodiments, the offer window (406) may display details relating to a received offer. The details may include a service name (408), an entity name (410), a service description (412), the offered price (414), the savings (416), and a “purchase” button (418).

The offer window may be configured to display basic information related to a received offer from an outside entity. This basic information may include the offered service (408). For example, the window may display that the offer is a flight/hotel package. The window may also display which entity is offering the service. For example, the offer window (406) may display both the airline and hotel chain which are making the offer. The offer window (406) may also display a description (412) of the product or service being offered.

In certain embodiments, the offer window may display the price (414) being offered for the service or product. The offer window (406) may also display the savings (416) associated with the product or service being offered. In certain embodiments, a user may be provided with a means to accept and purchase (418) the offer through the computer calendar system.

In some embodiments, an offer for a desired product or service may be provided through an alternate means. For example, the offer may be provided through an email, text message, or a mailed letter. A user may be given a link to a website in order to accept the offer. Additionally or alternatively, a user may have the option to call a sales agent for the business making the offer.

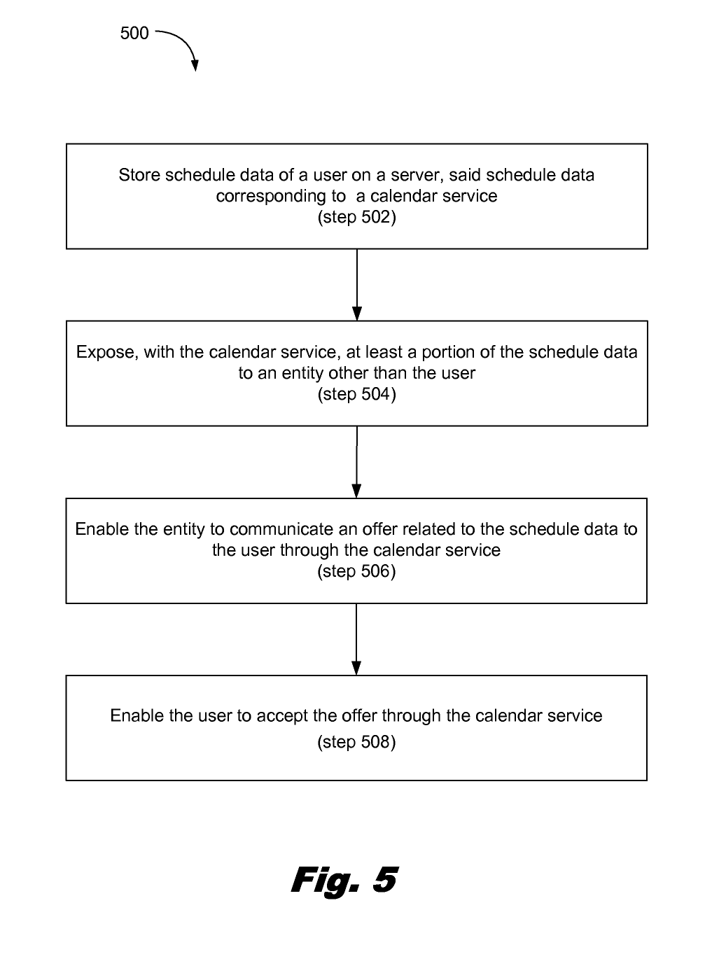

FIG. 5 is a flowchart showing an illustrative method for publishing schedule data within a calendar application to a number of entities and allowing the entities to make offers to a user of the calendar application. According to certain embodiments, the method may include storing (step 502) schedule data of a user on a server, the schedule data corresponding to a calendar service, exposing (step 504), with the calendar service, at least a portion of the schedule data to an entity other than the user, and enabling (step 506) the entity to communicate an offer related to the schedule data to the user through the calendar service. The method may further include enabling (step 508) the user to accept the offer through the calendar service.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims.

What is claimed is:

1. A method for providing schedule related information to external entities, the method comprising:
storing schedule data of a user on a server, said schedule data corresponding to a computerized calendar service;
exposing, with said computerized calendar service, at least a portion of said schedule data stored by said server to an entity other than said user; and
enabling said entity to communicate an offer based on said schedule data to at least said user.

2. The method of claim 1, in which said portion of said schedule data exposed to said entity comprises a description of at least one of: a product requested by said user and a service requested by said user.

3. The method of claim 2, in which said entity is a provider of said product or service requested by said user, and said offer comprises a solicitation to provide said product or service requested by said user to said user for a specific price.

4. The method of claim 2, in which said product or service requested by said user is associated with a specific date and time in said portion of said schedule data exposed to said entity.

5. The method of claim 2, in which said product or service requested by said user is associated with a specified range of dates and times in said portion of said schedule data exposed to said entity.

6. The method of claim 2, in which said product or service requested by said user comprises at least one of: transportation reservations, lodging reservations, and meal reservations.

7. The method of claim 1, further comprising charging said entity a fee for said portion of said schedule data exposed to said entity.

8. The method of claim 1, further comprising maintaining an identity of said user anonymous to said entity.

9. The method of claim 1, in which said offer is communicated to said user through said computerized calendar service.

10. The method of claim 9, further comprising enabling said user to accept said offer through said computerized calendar service.

11. The method of claim 1, in which said computerized calendar service comprises an online internet calendar service.

12. A server system comprising:
a processor; and
a memory communicatively coupled to said processor;
in which said processor is configured to:
store schedule data of a user on said memory, said schedule data corresponding to a calendar service;
expose, with said calendar service, at least a portion of said schedule data to an entity other than said user; and
enable said entity to communicate an offer based on said schedule data to at least said user.

13. The system of claim 12, in which said portion of said schedule data exposed to said entity comprises a description of at least one of: a product requested by said user and a service requested by said user.

14. The system of claim 13, in which said entity is a provider of said product or service requested by said user, and said offer comprises a solicitation to provide said product or service requested by said user to said user for a specific price.

15. The system of claim 13, in which said product or service requested by said user is associated with a specific date and time in said portion of said schedule data exposed to said entity.

16. The system of claim 13, in which said product or service requested by said user is associated with a specified range of dates and times in said portion of said schedule data exposed to said entity.

17. The system of claim 13, in which said product or service requested by said user comprises at least one of: transportation reservations, lodging reservations, and meal reservations.

18. The system of claim 12, in which said offer is communicated to said user through said calendar service.

19. The system of claim 18, in which said processor is further configured to enable said user to accept said offer through said calendar service.

20. A computer program product for providing schedule related information to external entities, said computer program product comprising:
a computer readable storage medium having computer readable program code embodied therewith, the computer readable program code comprising:
computer readable program code configured to store schedule data of a user on said memory, said schedule data corresponding to a calendar service;
computer readable program code configured to expose, with said calendar service, at least a portion of said schedule data to an entity other than said user; and
computer readable program code configured to enable said entity to communicate an offer based on said schedule data to at least said user.
